(19) United States
(12) Patent Application Publication
(10) Pub. No.: US 2015/0149356 A1
(43) Pub. Date: May 28, 2015

(54) METHOD AND SYSTEM FOR AUTHENTICATING CROSS-BORDER FINANCIAL CARD TRANSACTIONS

(71) Applicant: MasterCard International Incorporated, Purchase, NY (US)

(72) Inventor: Jason A. FELDMAN, New York, NY (US)

(73) Assignee: MasterCard International Incorporated, Purchase, NY (US)

(21) Appl. No.: 14/087,910

(22) Filed: Nov. 22, 2013

(51) Int. Cl. G06Q 20/40; G06Q 20/10

(52) U.S. Cl. CPC G06Q 20/405; G06Q 20/10
USPC 705/44

(57) ABSTRACT

A method for scoring a cross-border transaction includes: storing a consumer profile, the consumer profile including data related to a consumer including an account identifier corresponding to a payment account associated with the related consumer and a device identifier corresponding to a computing device associated with a first country; receiving a data file originating from the computing device, the data file including the device identifier and an indication of the computing device being located in a second country; receiving an authorization request for a cross-border payment transaction, the authorization request originating from the second country and including the account identifier; identifying a fraud score based on at least one fraud rule and based on at least the received indication of the computing device being located in the second country; and transmitting the authorization request and the identified fraud score for approval or denial of the cross-border payment transaction.

### FIELD

The present disclosure relates to the scoring and processing of cross-border payment transactions, specifically the use of device data and/or consumer identifiers to identify movement of a consumer from one country to another for the scoring of a payment transaction involving the consumer originating in the latter country.

### BACKGROUND

Payment card fraud can often affect and frustrate a number of parties involved in the payment card processing system. Consumers whose payment cards or payment accounts may be compromised may lose money and time, and may have to expend significant time and resources to regain what was lost, which may cause a considerable amount of stress. Merchants who conduct transactions with fraudulently used payment cards or payment accounts may suffer a loss for the amount of the transaction if the issuer refuses to honor the fraudulent transaction. Issuers may also expend significant time and resources in order to attempt to prevent, and remediate, such fraud.

In an effort to help curb the occurrence of fraudulent payment card transactions, maybe payment card issuers and processors may automatically deny, or otherwise indicate or flag as fraudulent, payment transactions that originate in a country outside of the country in which a payment card was issued, particularly for consumers who may not regularly travel outside of their home country. This may easily and quickly prevent fraudulent transactions using the consumer's payment account anywhere outside of their home country, which may significantly narrow the possibilities of fraud on the payment account.

However, such consumers may be quickly surprised if they travel to another country and attempt to use their payment card, only to have their transactions denied. Some systems and methods have been developed to identify the geographic location of a consumer's mobile communication device (e.g., a cell phone), and then use the identified location to approximate a location of the consumer for identifying the possibility of fraud for a payment transaction involving the consumer's payment account. However, consumers may not always be in possession of a suitable mobile device, or such devices may not always be able to communicate their location (e.g., outside of a service area). Particularly, in instances where a consumer is outside of their home country, they may be outside of an eligible service area for their mobile device, rendering such systems and methods for preventing fraud ineffective.

Thus, there is a need for a technical system to identify movement of a consumer from their home country to a second country for use in identifying fraud scores for payment transactions originating in the second country.

### SUMMARY

The present disclosure provides a description of systems and methods for the scoring of cross-border transactions.

A method for scoring a cross-border transaction includes: storing, in a database, a consumer profile, wherein the consumer profile includes data related to a consumer including at least an account identifier corresponding to a payment account associated with the related consumer and a device identifier corresponding to a computing device associated with a first country; receiving, by a receiving device, a data file originating from the computing device, wherein the data file includes at least the device identifier and an indication of the computing device being located in a second country; receiving, by the receiving device, an authorization request for a cross-border payment transaction, wherein the authorization request originates from the second country and includes at least the account identifier; identifying, by a processing device, a fraud score based on at least one fraud rule and based on at least the received indication of the computing device being located in the second country; and transmitting, by a transmitting device, at least the authorization request and the identified fraud score for approval or denial of the cross-border payment transaction.

Another method for scoring a cross-border transaction includes: storing, in a database, a consumer profile, wherein the consumer profile includes data related to a consumer including at least an account identifier corresponding to a payment account associated with the related consumer and a device identifier corresponding to a computing device associated with a first country; receiving, by a receiving device, a notification originating from a second country indicating the computing device corresponding to the device identifier being located in the second country; receiving, by the receiving device, an authorization request for a cross-border payment transaction, wherein the authorization request originates from the second country and includes at least the account identifier; identifying, by a processing device, a fraud score based on at least one fraud rule and based on at least the received indication of the computing device being located in the second country; and transmitting, by a transmitting device, at least the authorization request and the identified fraud score for approval or denial of the cross-border payment transaction.

Another method for scoring a cross-border transaction includes: storing, in a database, a consumer profile, wherein the consumer profile includes data related to a consumer including at least an account identifier corresponding to a payment account associated with the related consumer, a consumer identifier, and a first country associated with the related consumer; receiving, by a receiving device, a notification indicating use of the consumer identifier on a webpage or service via a computing device located in a second country; receiving, by the receiving device, an authorization request for a cross-border payment transaction, wherein the authorization request originates from the second country and includes at least the account identifier; identifying, by a processing device, a fraud score based on at least one fraud rule and based on at least the received indication of the computing device being located in the second country; and transmitting, by a transmitting device, at least the authorization request and the identified fraud score for approval or denial of the cross-border payment transaction.

A system for scoring a cross-border transaction includes a database, a receiving device, a processing device, and a transmitting device. The database is configured to store a consumer profile, wherein the consumer profile includes data related to a consumer including at least an account identifier corresponding to a payment account associated with the related consumer and a device identifier corresponding to a computing device associated with a first country. The receiving device is configured to receive: a data file originating from the computing device, wherein the data file includes at least the device identifier and an indication of the computing device being located in a second country; and an authorization request for a cross-border payment transaction, wherein the authorization request originates from the second country and includes at least the account identifier. The processing device is configured to identify a fraud score based on at least one fraud rule and based on at least the received indication of the computing device being located in the second country. The transmitting device is configured to transmit at least the authorization request and the identified fraud score for approval or denial of the cross-border payment transaction.

Another system for scoring a cross-border transaction includes a database, a receiving device, a processing device, and a transmitting device. The database is configured to store a consumer profile, wherein the consumer profile includes data related to a consumer including at least an account identifier corresponding to a payment account associated with the related consumer and a device identifier corresponding to a computing device associated with a first country. The receiving device is configured to receive: a notification originating from a second country indicating the computing device corresponding to the device identifier being located in the second country; and an authorization request for a cross-border payment transaction, wherein the authorization request originates from the second country and includes at least the account identifier. The processing device is configured to identify a fraud score based on at least one fraud rule and based on at least the received indication of the computing device being located in the second country. The transmitting device is configured to transmit at least the authorization request and the identified fraud score for approval or denial of the cross-border payment transaction.

Another system for scoring a cross-border transaction includes a database, a receiving device, a processing device, and a transmitting device. The database is configured to store a consumer profile, wherein the consumer profile includes data related to a consumer including at least an account identifier corresponding to a payment account associated with the related consumer, a consumer identifier, and a first country associated with the related consumer. The receiving device is configured to receive: a notification indicating use of the consumer identifier on a webpage or service via a computing device located in a second country; and an authorization request for a cross-border payment transaction, wherein the authorization request originates from the second country and includes at least the account identifier. The processing device is configured to identify a fraud score based on at least one fraud rule and based on at least the received indication of the computing device being located in the second country. The transmitting device is configured to transmit at least the authorization request and the identified fraud score for approval or denial of the cross-border payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A and 1B are a high level architecture illustrating a system for the scoring of a cross-border transaction using movement of a computing device associated with a consumer in accordance with exemplary embodiments.

FIGS. 2A and 2B are a high level architecture illustrating a system for the scoring of a cross-border transaction using movement of a consumer identifier used on multiple computing devices in accordance with exemplary embodiments.

FIG. 3 is a block diagram illustrating the processing server of FIGS. 1A, 1B, 2A, and 2B for the scoring of cross-border payment transactions in accordance with exemplary embodiments.

FIGS. 4A and 4B are a flow diagram illustrating a process for the identification of a fraud score for a cross-border payment transaction based on movement of a computing device in accordance with exemplary embodiments.

FIGS. 5A and 5B are a flow diagram illustrating a process for the identification of a fraud score for a cross-border payment transaction based on movement of a consumer identifier in accordance with exemplary embodiments.

FIGS. 6-8 are flow charts illustrating exemplary methods for the scoring of cross-border transactions in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### Systems for the Scoring of Cross-Border Payment Transactions

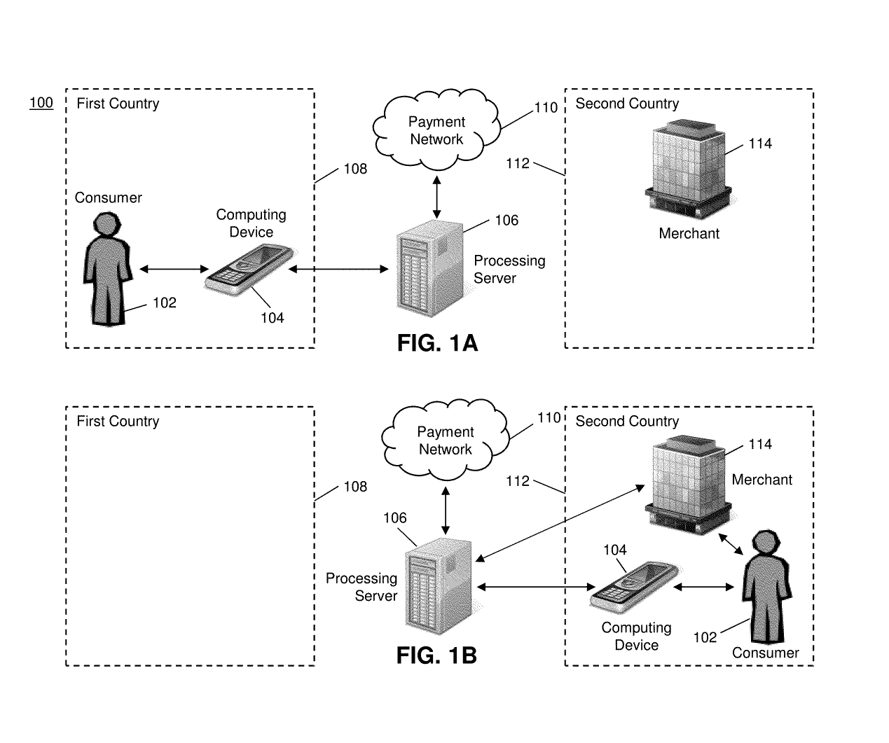

FIGS. 1A and 1B illustrate a system 100 for the scoring of a cross-border payment transaction based on the movement of a computing device associated with a consumer.

The system 100 may include a consumer 102. The consumer 102 may be in possession of or otherwise associated with a computing device 104. The computing device 104 may be any type of computing device suitable for performing the functions as discussed herein, such as a desktop computer, laptop computer, notebook computer, tablet computer, cellular phone, smart phone, or other suitable device as will be apparent to persons having skill in the relevant art. The consumer 102 and the computing device 104 may be located in a first country 108. In some instances, the first country 108 may be a country of residence or citizenship of the consumer 102. In other instances, the first country 108 may be a country in which a payment account for which the consumer 102 is authorized is based.

The system 100 may also include a processing server 106. The processing server 106, discussed in more detail below, may receive a data file originating from the computing device 104, such as a cookie. The data file may include at least a device identifier associated with the computing device 104 (e.g., for identification of the computing device 104) and an indication that the computing device 104 is located in the first country 108. For example, the data file may originate from the computing device 104 and include an internet protocol address assigned to the computing device 104 that indicates that the computing device 104 is located in the first country 108.

The processing server 106 may be in communication with a payment network 110. The processing server 106 may notify the payment network 110 of the location of the computing device 104 being located in the first country 108. In some instances, the payment network 110 may request identification of the current country of location of the computing device 104 associated with the consumer 102 upon the receipt of an authorization request for a payment transaction involving the consumer 102. The processing server 106 may then respond to the payment network 110 with the first country 108 and/or a fraud score generated and based on the identified country of location of the computing device 104. In some instances, the processing server 106 may be a part of the payment network 110.

As illustrated in FIG. 1B, the consumer 102 may travel to a second country 112 with the computing device 104. While at the second country 112, the consumer 102 may conduct a payment transaction with a merchant 114. As part of the payment transaction, the merchant 114 (e.g., or an acquirer associated with the merchant 114) may submit an authorization request for the payment transaction for processing. The processing server 106 may receive the authorization request (e.g., directly from the merchant 114, via the payment network 110, etc.), which may originate from the second country 112 and include an identifier associated with the consumer 102 used to identify the consumer 102 as being involved in the payment transaction.

The processing server 102 may also receive a data file from the computing device 104. In some instances, the processing server 106 may request the data file following the receipt of the authorization request. In another instance, the processing server 106 may regularly receive data files from the computing device 104. In other instances, the computing device 104 may transmit data files to the processing server 106 as instructed by the consumer 102, the processing server 106, or a third party. Methods for the transmitting of data files, such as cookies, from the computing device 104 to the processing server 106 will be apparent to persons having skill in the relevant art.

The data file received from the computing device 104 may include the device identifier associated with the computing device 104 and an indication of the computing device 104 being located in the second country 110, such as an internet protocol address associated with the second country 110. The processing server 106 may then identify a fraud score based on one or more fraud rules and based on the indication of the computing device 104 associated with the consumer 102 being located in the second country 112. The processing server 106 may transmit the fraud score (e.g., and the authorization request) to the payment network 110 for processing of the payment transaction. In some instances, the fraud score may be further based on a time at which the indication of the computing device 104 being located in the second country 112 is obtained and/or received. For example, the indication may be a stronger or weaker indicator of an authentic transaction if the computing device 104 is identified in the second country 112 closer or farther away from the authorization request, respectively.

By identifying that the computing device 104 is located in the second country 112, and thereby assuming the consumer 102 is also located in the second country 112, the payment network 110 may be able to process a cross-border transaction involving the consumer 102 that originates from the second country 112 with confidence. Conversely, if the computing device 104 is still located within the first country 108 when an authorization request originating from the second country 112 is received, the payment network 110 may be confident that a fraudulent transaction is being attempted. Such a system may improve over traditional methods for identifying the location of a consumer via a mobile device as the computing device 104 need not be a mobile device, may not require a regular connection to a network for transmission, and may not be limited by service areas.

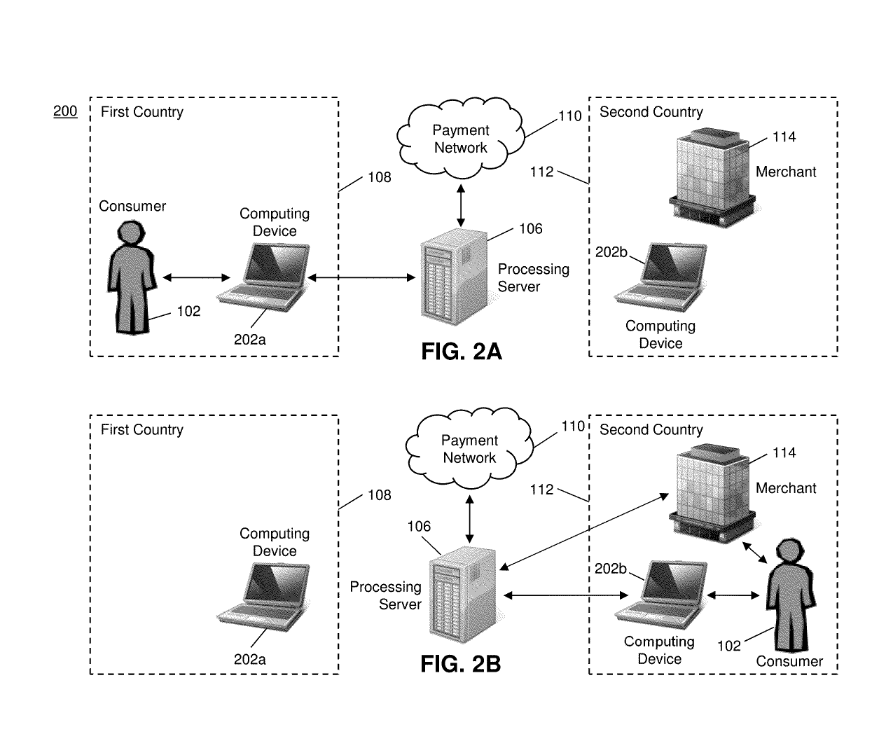

FIGS. 2A and 2B illustrate an alternative system 200 for scoring a cross-border payment transaction. In the system 200, the consumer 102 may use a computing device 202a, such as a desktop computer, laptop computer, smart phone, etc., to perform a function that requires identification of the consumer 102. For example, the consumer 102 may log on to a website using a username or other unique identifier associated with the consumer 102 (e.g., a consumer identifier). The computing device 202a, or a third party (e.g., the website to which the consumer 102 logged on), may transmit an indication to the processing server 106 that the consumer 102 has logged on using the computing device 202a, as well as an indication that the computing device 202a is located in the first country 108. It will be apparent to persons having skill in the relevant art that the computing device 202a may or may not be associated with the consumer 102. For example, the computing device 202a may be a personal computing device of the consumer 102, or may be a computing device not directly associated with the consumer 102, such as a publically available computing device (e.g., at an Internet café, library, etc.).

As illustrated in FIG. 2B, the consumer 102 may then travel to the second country 112. While in the second country 112, the consumer 102 may use a second computing device, the computing device 202b, to log on to the same website via the same consumer identifier. The computing device 202b or a third party may then transmit an indication to the processing server 106 that the consumer 102 accessed the computing device 202b located in the second country 112.

The consumer 102 may conduct a payment transaction with the merchant 114. The merchant 114, or an acquirer associated with the merchant 114, may submit an authorization request for the payment transaction, which may be received by the processing server 106. The authorization request may be for a cross-border transaction and may originate from the second country 112. The processing server 106 may identify the request as originating from the second country 112 and may identify the previously received indication that the consumer 102 is located in the second country 112 based on their accessing of the computing device 202b.

The processing server 106 may then identify a fraud score for the payment transaction based one or more fraud rules and based on the received indication of the computing device 202b accessed by the consumer 102 as being located in the second country 112. The processing server 106 may transmit the fraud score (e.g., and the authorization request) to the payment network 110 for processing. In embodiments where the processing server 106 may be a part of the payment network 110, the processing server 106 may perform functions for processing the payment transaction as will be apparent to persons having skill in the relevant art. In some instances, the fraud score may be further based on a time at which the indication of the consumer 102 as being located in the second country 112 is obtained and/or received. For example, the indication may be a stronger or weaker indicator of an authentic transaction if the consumer 102 has been identified via the computing device 202b closer or farther away from the authorization request, respectively.

The system 200 may improve on existing systems and methods for scoring cross-border payment transactions as it may not be tied to a specific computing device. As such, the consumer 102 may access any computing device (e.g., the computing device 202b) in the second country 112 and may still be identified as being located in the second country 112. Such a system may result in more accurate information that may be received more often than traditional systems. In some instances, consumers may be more likely to access a computing device 202b abroad rather than take their own computing device 104 with them when they travel. In such instances, the system 200 may still be effective in identifying potential fraud or lack thereof, as opposed to traditional systems and methods that may be tied to the geographic location of a specific computing device associated with the consumer 102.

### Processing Server

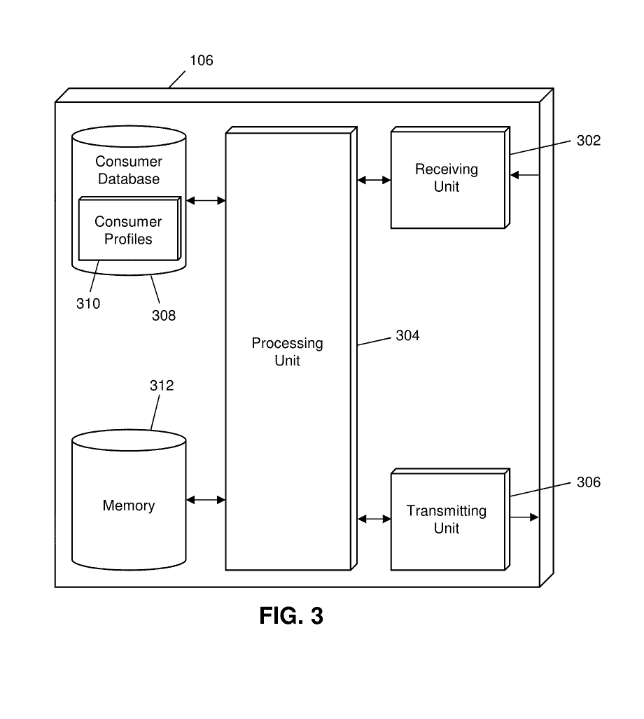

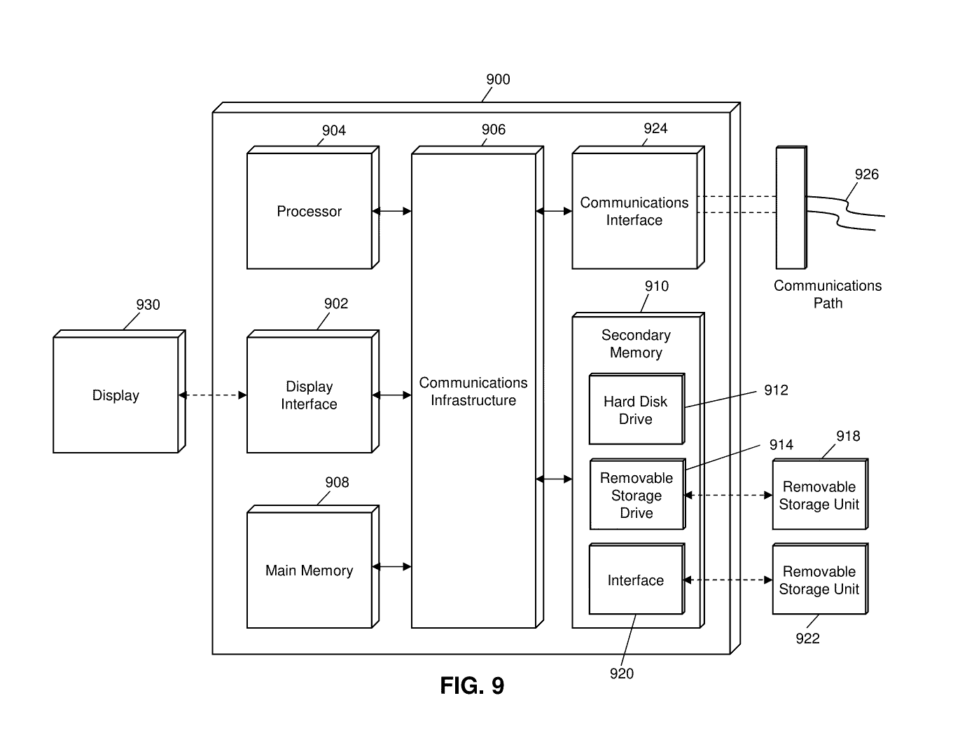

FIG. 3 illustrates an embodiment of the processing server 106 of the systems 100 and 200. It will be apparent to persons having skill in the relevant art that the embodiment of the processing server 106 illustrated in FIG. 3 is provided as illustration only and may not be exhaustive to all possible configurations of the processing server 106 suitable for performing the functions as discussed herein. For example, the computer system 900 illustrated in FIG. 9 and discussed in more detail below may be a suitable configuration of the processing server 106.

The processing server 106 may include a receiving unit 302. The receiving unit 302 may be configured to receive data over one or more networks via one or more network protocols. The receiving unit 302 may receive data files from the computing device 104, the data files including a device identifier associated with the computing device 104 and an indication of the country of location of the computing device 104. The device identifier may be a unique value associated with the computing device 104, such as a media access control address, registration number, serial number, product code, computer name, or any other suitable value as will be apparent to persons having skill in the relevant art.

The receiving unit 302 may also receive a notification from a computing device 202 or other source indicating that the consumer 102 has accessed the computing device 202. The notification may include at least a consumer identifier associated with the consumer 102 and an indication of the country of location of the computing device 202. The consumer identifier may be a unique value associated with the consumer 102 used for identification, such as an identification number, a payment account number (e.g., associated with a payment account of the consumer 102), a username, an e-mail address, a phone number, or any other suitable value as will be apparent to persons having skill in the relevant art.

The receiving unit 302 may be further configured to receive authorization requests for payment transactions involving the consumer 102. The authorization request may include at least an identifier associated with the consumer 102, such as the consumer identifier, a payment account identifier, etc., and an indication of the country of origination of the authorization request. In one embodiment, a data field included in the authorization request may include the geographic location of the originating source of the authorization request (e.g., of the merchant 114).

The processing server 106 may also include a processing unit 304. The processing unit 304 may be any type of processor or processors configured to perform the functions as disclosed herein, as discussed in more detail below. The processing unit 304 may be configured to store and identify consumer data associated with consumers 102 in a consumer database 308 as one or more consumer profiles 310. Each consumer profile 310 may include data related to a consumer 102 including at least an account identifier corresponding to a payment account associated with the related consumer 102. In some embodiments, each consumer profile 310 may also include a device identifier associated to the computing device 104 associated with the first country 108. In another embodiment, each consumer profile 310 may additionally, or alternatively, include the consumer identifier associated with the related consumer 102 and the first country 108 associated with the related consumer 102.

Once an authorization request is received by the receiving unit 302, the processing unit 304 may identify a consumer profile 310 associated with the consumer 102 involved in the corresponding payment transaction based on the account identifier and/or consumer identifier included in the authorization request. The processing unit 304 may then identify a fraud score for the payment transaction based on one or more fraud rules and based on the data received by the receiving unit 302 (e.g., included in the data file and/or the notification) and the data included in the consumer profile 310. In some instances, the data received by the receiving unit 302 may be stored in the corresponding consumer profile 310 prior to the identification of the fraud score for the payment transaction.

The one or more fraud rules may be stored in a memory 312. The memory 312 may be configured to store the one or more fraud rules and any additional data that may be necessary for performing the functions as disclosed herein as will be apparent to persons having skill in the relevant art. The fraud rules may be rules for the identification of a fraud score for a payment transaction based on transaction data, consumer data, merchant data, and additional data sources as will be apparent to persons having skill in the relevant art. In some instances, the fraud score may have a time decay. For example, the fraud score may only be applicable for a period of time after identification of the fraud score and/or may lower (e.g., be less influential to approval or denial of the payment transaction) over time following identification.

The processing server 106 may further include a transmitting unit 306. The transmitting unit 306 may be configured to transmit data over one or more networks via one or more network protocols. The transmitting unit 306 may be configured to transmit the identified fraud score to the payment network 110 for use in approving or denying the payment transaction. In some embodiments, the transmitting unit 306 may transmit the authorization request for the payment transaction concurrently with, or in addition to, the identified fraud score.

### Process for Identifying a Fraud Score Based on Computing Device Movement

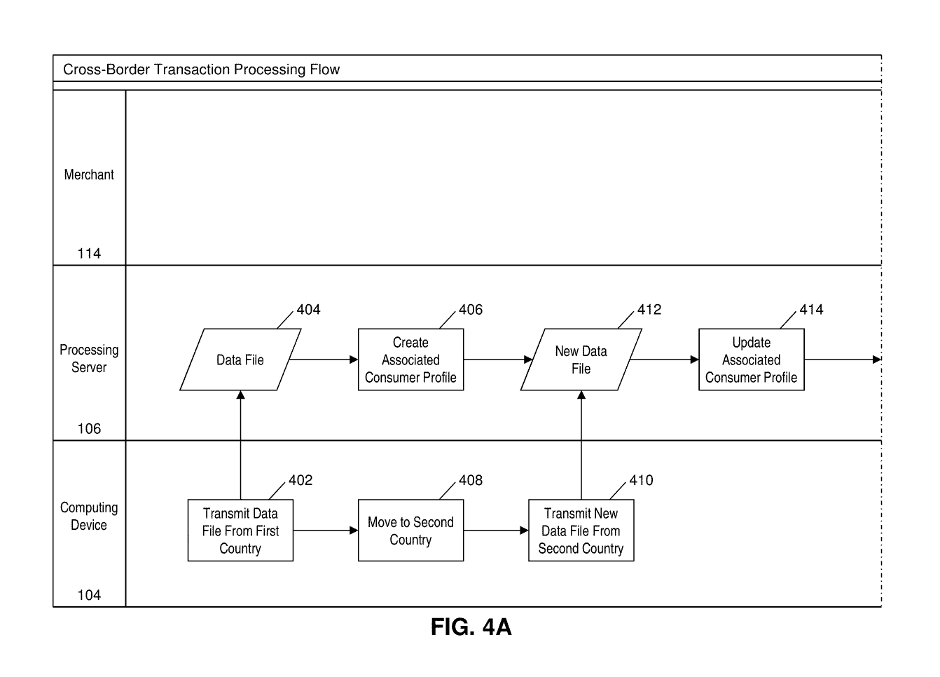

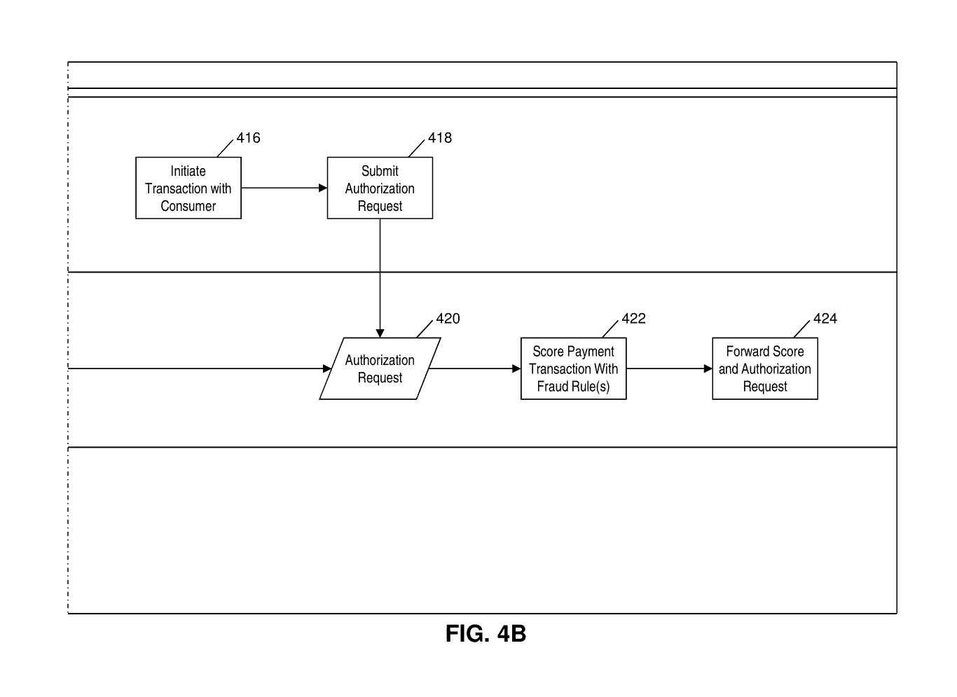

FIGS. 4A and 4B illustrate a process for identifying a fraud score for a cross-border payment transaction based on the movement of a computing device associated with a consumer involved in the cross-border payment transaction.

In step 402, the computing device 104 may transmit a data file to the processing server 106 while located in the first country 108. The data file may be a cookie or other suitable type of data file, such as global positioning system or Internet service provider log data or other data that will be apparent to persons having skill in the relevant art. In step 404, the processing server 106 may receive the data file, which may include a device identifier associated with the computing device 104 and an indication of the computing device 104 being located in the first country 108, such as an internet protocol address associated with the first country 108.

In step 406, the processing server 106 may create a consumer profile 310 to be stored in the consumer database 308 for the consumer 102 associated with the computing device 104. The consumer profile 310 may include at least the device identifier associated with the computing device 104 and an account identifier corresponding to a payment account associated with the consumer 102. In step 408, the consumer 102 may move the computing device 102 to the second country 112. In step 410, the computing device 104 may transmit a new data file to the processing server 106 originating from the second country 112.

In step 412, the processing server 106 may receive the new data file, which may include the device identifier and an indication of the computing device 104 now being located in the second country 112. In an alternative embodiment, the computing device 102 may be moved to the second country 112, but not transmit a new data file to the processing server 106. In such an embodiment, a computing network (e.g., a Wi-Fi network, local area network, etc.) or other third party entity or service (e.g., a mobile network operator) located in the second country 112 may detect the computing device 102 and transmit a notification to the processing server 106 indicating the detection of the computing device 102 in the second country 112. For example, the computing device 102 may be detected by a Wi-Fi network in the second country 112 but be unable to log in to the network and thus unable to transmit a new data file to the processing server 106. In such an example, the Wi-Fi network (e.g., an entity operating the network) may transmit the notification to the processing server 106.

In step 414, the processing server 106 may update the consumer profile 310 associated with the computing device 104 (e.g., identified using the device identifier), to indicate the computing device 104 being located in the second country 112. In step 416, the merchant 114, located in the second country 112, may initiate a payment transaction with the consumer 102. As part of the payment transaction, the consumer 102 may present payment details (e.g., via a payment card) for funding of the payment transaction, where the payment details include at least an account identifier corresponding to a payment account associated with the consumer 102. In step 418, the merchant 114, or another entity on behalf of the merchant 114 (e.g., an acquirer), may submit an authorization request for the payment transaction to the processing server 106 (e.g., via the payment network 110).

In step 420, the processing server 106 may receive the authorization request. The authorization request may include the account identifier and an indication of the authorization request originating from the second country 112. The processing unit 304 of the processing server 106 may identify the consumer profile 310 associated with the consumer 102 (e.g., using the account identifier) and, in step 422, may identify a fraud score for the payment transaction. The fraud score may be based on one or more fraud rules stored in the memory 312 and based on the updated consumer profile 310 including the received indication of the computing device 104 being located in the second country 112. In step 424, the transmitting unit 306 of the processing server 106 may transmit the identified fraud score and authorization request to the payment network 110 for processing of the cross-border payment transaction.

### Process for Identifying a Fraud Score Based on Consumer Movement

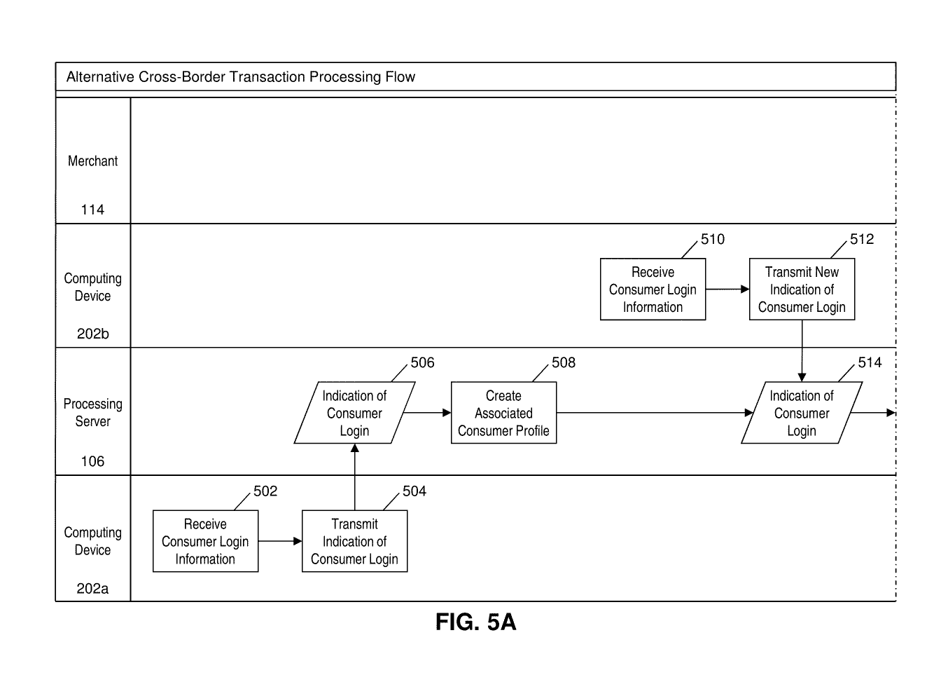

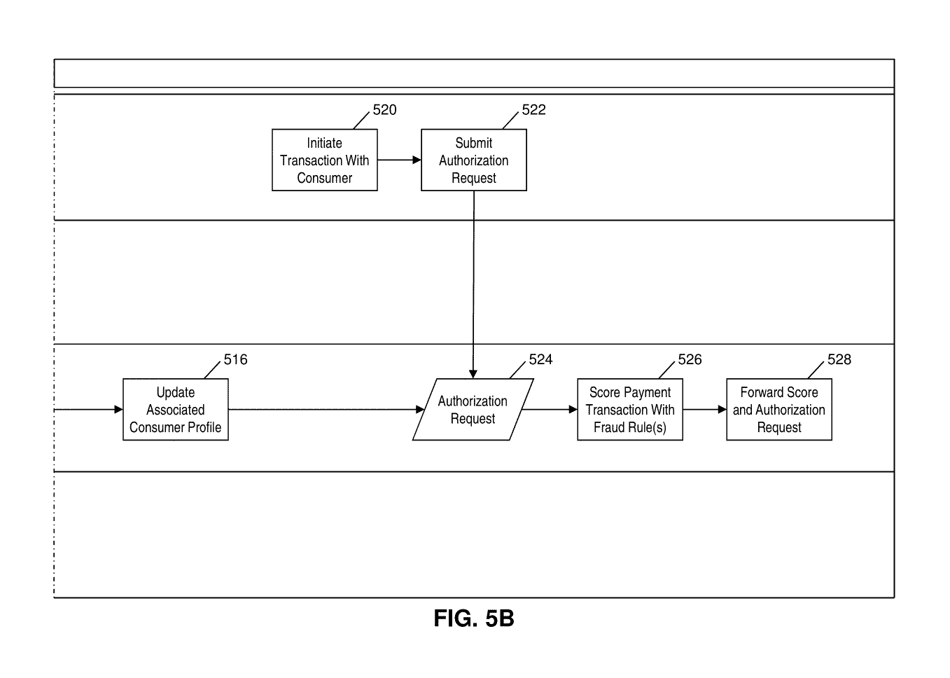

FIGS. 5A and 5B illustrate a process for identifying a fraud score for a cross-border payment transaction based on the movement of a consumer involved in the cross-border payment transaction based on the consumer's access of different computing devices.

In step 502, the computing device 202a may receive consumer login information from the consumer 102 to login to a website or service via the computing device 202a. In step 504, the computing device 202a may transmit an indication of the consumer login to the processing server 106. In some embodiments, the indication may be transmitted by a third party, such as a web server to which the consumer 102 has logged in via the computing device 202a. In step 506, the processing server 106 may receive the indication. The indication may include at least the consumer identifier used by the consumer 102 and the country 108 of location of the computing device 202a.

In step 508, the processing server 106 may create a consumer profile 310 associated with the consumer 102 for storage in the consumer database 308. The consumer profile 310 may include at least an account identifier corresponding to a payment account associated with the consumer 102, the consumer identifier, and the first country 108 as being associated with the consumer 102 as identified in the received indication.

In step 510, the computing device 202b, located in the second country 112, may receive consumer login information from the consumer 102 to login to the website or service via the computing device 202b. In step 512, the computing device 202b (e.g., or a third party) may transmit a new indication of the consumer login to the processing server 106. In step 514, the processing server 106 may receive the new indication, which may include the consumer identifier and an indication of the computing device 202b as being located in the second country 112. In step 516, the processing server 106 may update the associated consumer profile 310 to include the indication of the computing device 202b used by the consumer 102 as being located in the second country 112.

In step 520, the merchant 114 may initiate a payment transaction with the consumer 102, which may include the consumer 102 furnishing at least the account identifier for the payment account associated with the consumer 102 to the merchant 114. In step 522, the merchant 114 (e.g., and/or the acquirer) may submit an authorization request to the processing server 106, which may receive the authorization request in step 524. The authorization request may include the account identifier and an indication of the merchant 114 being located in the second country 112.

The processing unit 304 of the processing server 106 may identify the consumer profile 310 associated with the consumer 102 (e.g., using the account identifier) and, in step 526, may identify a fraud score for the payment transaction. The fraud score may be based on one or more fraud rules stored in the memory 312 and based on the updated consumer profile 310 including the received indication of the computing device 202b being located in the second country 112. In step 528, the transmitting unit 306 of the processing server 106 may transmit the identified fraud score and authorization request to the payment network 110 for processing of the cross-border payment transaction.

### First Exemplary Method for Scoring a Cross-Border Transaction

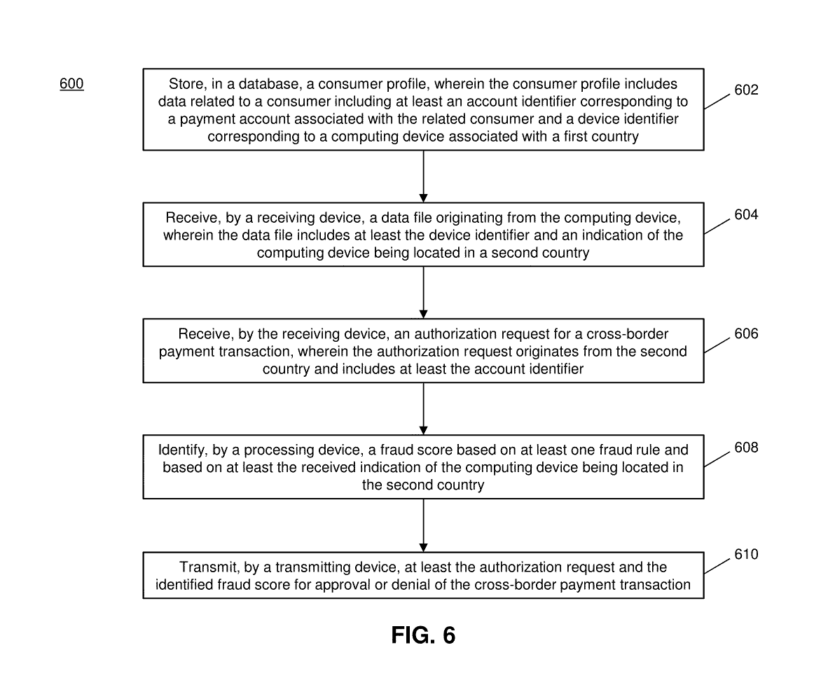

FIG. 6 illustrates a method 600 for the scoring of a cross-border payment transaction.

In step 602, a consumer profile (e.g., the consumer profile 310), may be stored, in a database (e.g., the consumer database 308), wherein the consumer profile 310 includes data related to a consumer (e.g., the consumer 102) including at least an account identifier corresponding to a payment account associated with the related consumer 102 and a device identifier corresponding to a computing device (e.g., the computing device 104) associated with a first country (e.g., the first country 108). In one embodiment, the device identifier may be a media access control address.

In step 604, a data file originating from the computing device 104 may be received, by a receiving device (e.g., the receiving unit 302), wherein the data file includes at least the device identifier and an indication of the computing device 104 being located in a second country (e.g., the second country 112). In one embodiment, the data file may be a cookie. In some embodiments, the consumer profile 310 may further include a consumer identifier, and the received data file may also further include the consumer identifier. In one embodiment, the consumer profile 310 may include an approved country listing including at least the first country 108 and not including the second country 112.

In step 606, an authorization request for a cross-border payment transaction may be received, by the receiving device 302, wherein the authorization request originates from the second country 112 and includes at least the account identifier.

In step 608, a fraud score may be identified, by a processing device (e.g., the processing unit 304), based on at least one fraud rule and based on at least the received indication of the computing device 104 being located in the second country 112. In some embodiments, the at least one fraud rule may include fraud rules based on at least one of: a credit history of the consumer 102, a credit rating of the consumer 102, a transaction amount of the cross-border payment transaction, a geographic location of the consumer 102 at the time of the cross-border payment transaction, a geographic location of a merchant (e.g., the merchant 114) involved in the cross-border payment transaction, and transaction history of the consumer 102.

In step 610, a transmitting device (e.g., the transmitting unit 306) may transmit at least the authorization request and the identified fraud score for approval or denial of the cross-border payment transaction.

### Second Exemplary Method for Scoring a Cross-Border Transaction

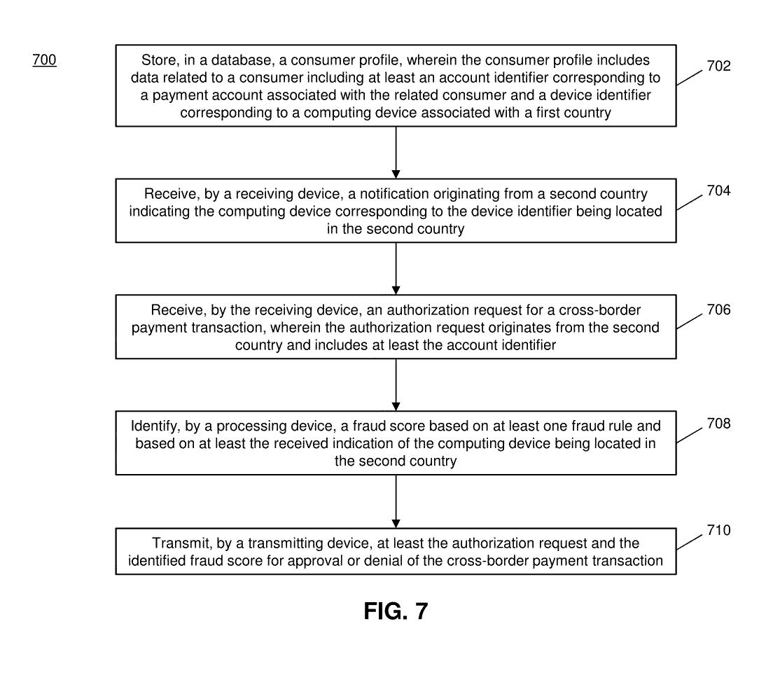

FIG. 7 illustrates an alternative method 700 for the scoring of a cross-border payment transaction.

In step 702, a consumer profile (e.g., the consumer profile 310), may be stored, in a database (e.g., the consumer database 308), wherein the consumer profile 310 includes data related to a consumer (e.g., the consumer 102) including at least an account identifier corresponding to a payment account associated with the related consumer 102 and a device identifier corresponding to a computing device (e.g., the computing device 104) associated with a first country (e.g., the first country 108). In one embodiment, the device identifier may be a media access control address.

In step 704, notification originating from a second country (e.g., the second country 112) may be received, by a receiving device (e.g., the receiving unit 302), indicating the computing device 104 corresponding to the device identifier being located in the second country 112. In one embodiment, the notification may be generated in response to detection of the computing device 104 in the second country 112 by a computing network. In some embodiments, the consumer profile 310 may further include a consumer identifier, and the received data file may also further include the consumer identifier. In one embodiment, the consumer profile 310 may include an approved country listing including at least the first country 108 and not including the second country 112.

In step 706, an authorization request for a cross-border payment transaction may be received, by the receiving device 302, wherein the authorization request originates from the second country 112 and includes at least the account identifier.

In step 708, a fraud score may be identified, by a processing device (e.g., the processing unit 304), based on at least one fraud rule and based on at least the received indication of the computing device 104 being located in the second country 112. In some embodiments, the at least one fraud rule may include fraud rules based on at least one of: a credit history of the consumer 102, a credit rating of the consumer 102, a transaction amount of the cross-border payment transaction, a geographic location of the consumer 102 at the time of the cross-border payment transaction, a geographic location of a merchant (e.g., the merchant 114) involved in the cross-border payment transaction, and transaction history of the consumer 102.

In step 710, a transmitting device (e.g., the transmitting unit 306) may transmit at least the authorization request and the identified fraud score for approval or denial of the cross-border payment transaction.

### Third Exemplary Method for Scoring a Cross-Border Transaction

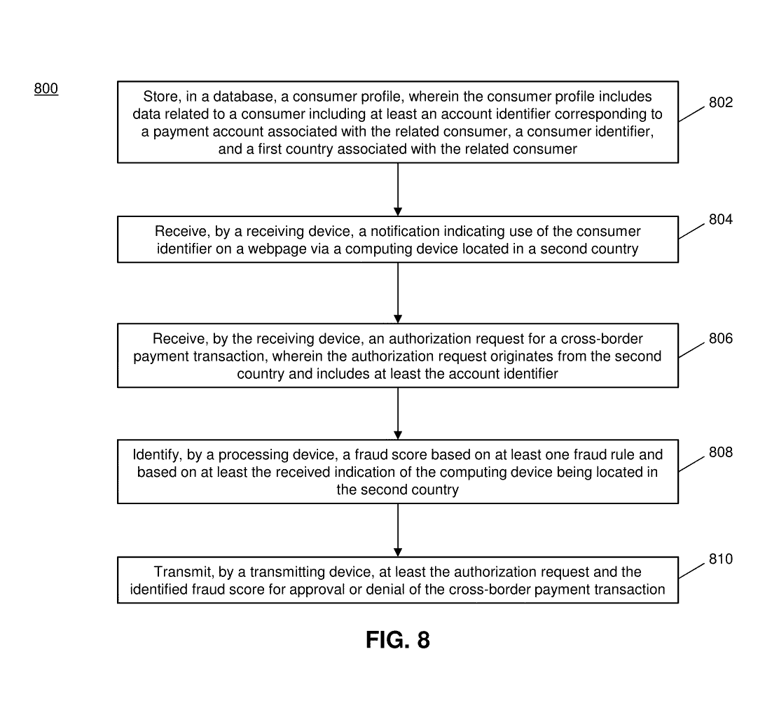

FIG. 8 illustrates another alternative method 800 for the scoring of a cross-border payment transaction.

In step 802, a consumer profile (e.g., the consumer profile 310) may be stored, in a database (e.g., the consumer database 308), wherein the consumer profile 310 includes data related to a consumer (e.g., the consumer 102) including at least an account identifier corresponding to a payment account associated with the related consumer 102, a consumer identifier, and a first country (e.g., the first country 108) associated with the related consumer 102. In one embodiment, the consumer identifier may be at least one of: a username, an e-mail address, a phone number, and a payment account number associated with the corresponding payment account.

In step 804, a receiving device (e.g., the receiving unit 302), may receive a notification indicating use of the consumer identifier on a webpage or service via a computing device (e.g., the computing device 202b) located in a second country (e.g., the second country 112). In one embodiment, the notification may be one of a cookie and a message originated from the webpage or service. In some embodiments, the consumer profile 310 may further include an approved country listing including at least the first country 108 and not including the second country 112. In one embodiment, the computing device 202b located in the second country 112 may be identified via an internet protocol (IP) address associated with the second country 112.

In step 806, an authorization request for a cross-border transaction may be received, by the receiving device 302, wherein the authorization request originates from the second country 112 and includes at least the account identifier.

In step 808, a fraud score may be identified, by a processing device (e.g., the processing unit 304), based on at least one fraud rule and based on at least the received indication of the computing device 202b being located in the second country 112. In some embodiments, the at least one fraud rule may include fraud rules based on at least one of: a credit history of the consumer 102, a credit rating of the consumer 102, a transaction amount of the cross-border payment transaction, a geographic location of the consumer 102 at the time of the cross-border payment transaction, a geographic location of a merchant (e.g., the merchant 114) involved in the cross-border payment transaction, and transaction history of the consumer 102.

In step 810, a transmitting device (e.g., the transmitting unit 306) may transmit at least the authorization request and the identified fraud score for approval or denial of the cross-border payment transaction.

### Computer System Architecture

FIG. 9 illustrates a computer system 900 in which embodiments of the present disclosure, or portions thereof, may be implemented as computer-readable code. For example, the processing server 106 of FIGS. 1A, 1B, 2A, and 2B may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, 5A, 5B, and 6-8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 4A, 4B, 5A, 5B, and 6-8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for scoring cross-border payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for scoring a cross-border transaction, comprising:
storing, in a database, a consumer profile, wherein the consumer profile includes data related to a consumer including at least an account identifier corresponding to a payment account associated with the related consumer and a device identifier corresponding to a computing device associated with a first country;
receiving, by a receiving device, a data file originating from the computing device, wherein the data file includes at least the device identifier and an indication of the computing device being located in a second country;
receiving, by the receiving device, an authorization request for a cross-border payment transaction, wherein the authorization request originates from the second country and includes at least the account identifier;
identifying, by a processing device, a fraud score based on at least one fraud rule and based on at least the received indication of the computing device being located in the second country; and
transmitting, by a transmitting device, at least the authorization request and the identified fraud score for approval or denial of the cross-border payment transaction.

2. The method of claim 1, wherein the device identifier is a media access control address.

3. The method of claim 1, wherein the data file is a cookie.

4. The method of claim 1, wherein the consumer profile further includes a consumer identifier, and wherein the data file further includes the consumer identifier.

5. The method of claim 1, wherein the consumer profile further includes an approved country listing including at least the first country and not including the second country.

6. The method of claim 1, wherein the at least one fraud rule includes fraud rules based on at least one of: a credit history of the consumer, a credit rating of the consumer, a transaction amount of the cross-border payment transaction, a geographic location of the consumer at the time of the cross-border payment transaction, a geographic location of a merchant involved in the cross-border payment transaction, and transaction history of the consumer.

7. A method for scoring a cross-border transaction, comprising:
storing, in a database, a consumer profile, wherein the consumer profile includes data related to a consumer including at least an account identifier corresponding to a payment account associated with the related consumer and a device identifier corresponding to a computing device associated with a first country;
receiving, by a receiving device, a notification originating from a second country indicating the computing device corresponding to the device identifier being located in the second country;
receiving, by the receiving device, an authorization request for a cross-border payment transaction, wherein the authorization request originates from the second country and includes at least the account identifier;
identifying, by a processing device, a fraud score based on at least one fraud rule and based on at least the received indication of the computing device being located in the second country; and
transmitting, by a transmitting device, at least the authorization request and the identified fraud score for approval or denial of the cross-border payment transaction.

8. The method of claim 7, wherein the device identifier is a media access control address.

9. The method of claim 7, wherein the notification is generated in response to detection of the computing device in the second country by a computing network.

10. The method of claim 7, wherein the consumer profile further includes a consumer identifier, and wherein the data file further includes the consumer identifier.

11. The method of claim 7, wherein the consumer profile further includes an approved country listing including at least the first country and not including the second country.

12. The method of claim 7, wherein the at least one fraud rule includes fraud rules based on at least one of: a credit history of the consumer, a credit rating of the consumer, a transaction amount of the cross-border payment transaction, a geographic location of the consumer at the time of the cross-border payment transaction, a geographic location of a merchant involved in the cross-border payment transaction, and transaction history of the consumer.

13. A method for scoring a cross-border transaction, comprising:
storing, in a database, a consumer profile, wherein the consumer profile includes data related to a consumer including at least an account identifier corresponding to a payment account associated with the related consumer, a consumer identifier, and a first country associated with the related consumer;
receiving, by a receiving device, a notification indicating use of the consumer identifier on a webpage or service via a computing device located in a second country;
receiving, by the receiving device, an authorization request for a cross-border payment transaction, wherein the authorization request originates from the second country and includes at least the account identifier;
identifying, by a processing device, a fraud score based on at least one fraud rule and based on at least the received indication of the computing device being located in the second country; and
transmitting, by a transmitting device, at least the authorization request and the identified fraud score for approval or denial of the cross-border payment transaction.

14. The method of claim 13, wherein the consumer identifier is at least one of: a username, an e-mail address, a phone number, and a payment account number associated with the corresponding payment account.

15. The method of claim 13, wherein the notification is one of a cookie and a message originated from the webpage or service.

16. The method of claim 13, wherein the consumer profile further includes an approved country listing including at least the first country and not including the second country.

17. The method of claim 13, wherein the computing device located in the second country is identified via an Internet Protocol (IP) address associated with the second country.

18. The method of claim 13, wherein the at least one fraud rule includes fraud rules based on at least one of: a credit history of the consumer, a credit rating of the consumer, a transaction amount of the cross-border payment transaction, a geographic location of the consumer at the time of the cross-border payment transaction, a geographic location of a merchant involved in the cross-border payment transaction, and transaction history of the consumer.

19. A system for scoring a cross-border transaction, comprising:
a database configured to store a consumer profile, wherein the consumer profile includes data related to a consumer including at least an account identifier corresponding to a payment account associated with the related consumer and a device identifier corresponding to a computing device associated with a first country;
a receiving device configured to receive
a data file originating from the computing device, wherein the data file includes at least the device identifier and an indication of the computing device being located in a second country, and
an authorization request for a cross-border payment transaction, wherein the authorization request originates from the second country and includes at least the account identifier;
a processing device configured to identify a fraud score based on at least one fraud rule and based on at least the received indication of the computing device being located in the second country; and
a transmitting device configured to transmit at least the authorization request and the identified fraud score for approval or denial of the cross-border payment transaction.

20. The system of claim 19, wherein the device identifier is a media access control address.

21. The system of claim 19, wherein the data file is a cookie.

22. The system of claim 19, wherein the consumer profile further includes a consumer identifier, and wherein the data file further includes the consumer identifier.

23. The system of claim 19, wherein the consumer profile further includes an approved country listing including at least the first country and not including the second country.

24. The system of claim 19, wherein the at least one fraud rule includes fraud rules based on at least one of: a credit history of the consumer, a credit rating of the consumer, a transaction amount of the cross-border payment transaction, a geographic location of the consumer at the time of the cross-border payment transaction, a geographic location of a merchant involved in the cross-border payment transaction, and transaction history of the consumer.

25. A system for scoring a cross-border transaction, comprising:
a database configured to store a consumer profile, wherein the consumer profile includes data related to a consumer including at least an account identifier corresponding to a payment account associated with the related consumer and a device identifier corresponding to a computing device associated with a first country;
a receiving device configured to receive
a notification originating from a second country indicating the computing device corresponding to the device identifier being located in the second country, and
an authorization request for a cross-border payment transaction, wherein the authorization request originates from the second country and includes at least the account identifier;
a processing device configured to identify a fraud score based on at least one fraud rule and based on at least the received indication of the computing device being located in the second country; and
a transmitting device configured to transmit at least the authorization request and the identified fraud score for approval or denial of the cross-border payment transaction.

26. The system of claim 25, wherein the device identifier is a media access control address.

27. The system of claim 25, wherein the notification is generated in response to detection of the computing device in the second country by a computing network.

28. The system of claim 25, wherein the consumer profile further includes a consumer identifier, and wherein the data file further includes the consumer identifier.

29. The system of claim 25, wherein the consumer profile further includes an approved country listing including at least the first country and not including the second country.

30. The system of claim 25, wherein the at least one fraud rule includes fraud rules based on at least one of: a credit history of the consumer, a credit rating of the consumer, a transaction amount of the cross-border payment transaction, a geographic location of the consumer at the time of the cross-border payment transaction, a geographic location of a merchant involved in the cross-border payment transaction, and transaction history of the consumer.

31. A system for scoring a cross-border transaction, comprising:
a database configured to store a consumer profile, wherein the consumer profile includes data related to a consumer including at least an account identifier corresponding to a payment account associated with the related consumer, a consumer identifier, and a first country associated with the related consumer;
a receiving device configured to receive
a notification indicating use of the consumer identifier on a webpage or service via a computing device located in a second country, and
an authorization request for a cross-border payment transaction, wherein the authorization request originates from the second country and includes at least the account identifier;
a processing device configured to identify a fraud score based on at least one fraud rule and based on at least the received indication of the computing device being located in the second country; and
a transmitting device configured to transmit at least the authorization request and the identified fraud score for approval or denial of the cross-border payment transaction.

32. The system of claim 31, wherein the consumer identifier is at least one of: a username, an e-mail address, a phone number, and a payment account number associated with the corresponding payment account.

33. The system of claim 31, wherein the notification is one of a cookie and a message originated from the webpage or service.

34. The system of claim 31, wherein the consumer profile further includes an approved country listing including at least the first country and not including the second country.

35. The system of claim 31, wherein the computing device located in the second country is identified via an Internet Protocol (IP) address associated with the second country.

36. The system of claim 31, wherein the at least one fraud rule includes fraud rules based on at least one of: a credit history of the consumer, a credit rating of the consumer, a transaction amount of the cross-border payment transaction, a geographic location of the consumer at the time of the cross-border payment transaction, a geographic location of a merchant involved in the cross-border payment transaction, and transaction history of the consumer.
